(19) United States
(12) Patent Application Publication
(10) Pub. No.: US 2018/0039958 A1
(43) Pub. Date: Feb. 8, 2018

(54) Intelligent Routing for repair, re-manufacture, or refurbishment based on economic parameters.

(71) Applicants: Roger David Bryant, Allen, TX (US); Craig James Boswell, Tioga, TX (US)

(72) Inventors: Roger David Bryant, Allen, TX (US); Craig James Boswell, Tioga, TX (US)

(21) Appl. No.: 15/677,530

(22) Filed: Aug. 15, 2017

Related U.S. Application Data
(60) Provisional application No. 62/371,943, filed on Aug. 8, 2016.

(51) Int. Cl. G06Q 10/00; G06Q 30/02; G06Q 50/28; G06Q 10/06

(52) U.S. Cl. CPC G06Q 10/20; G06Q 10/06315; G06Q 30/0206; G06Q 50/28

(57) ABSTRACT

An automated method for managing the repair, remanufacture, or refurbishment of electronic products, such as smart cellular phones and tablet computers, based on expected economic returns, beginning with the initial “triage” assessment, and continuing with established check points to validate continuation of the repair process. Parameters used to make this determination include the anticipated market value of the product, projected material and labor costs at any point in the process, and the expected probability of a successful repair completion.

Companies engaged in this business usually have a method of projecting the expected cost of repairing an electronic product. However, if the actual repair cost exceeds the projection, this is often not realized until after the completion of the repair or refurbishment, resulting in an economic loss. This automated method provides economically intelligent process routing to prevent that occurrence.

The Intelligent Routing process referred to in this title (herein referred to as the IR Process) can be used to profitably repair, re-manufacture or refurbish any manufactured item. It requires knowledge of the probable market value of the item after such operation has been performed, along with the cost associated with the IR Process. Our claim is that the Intelligent Routing process optimizes net value recovery in the reverse logistic process for manufactured goods.

A vital piece of information needed is a reasonable estimate of the value each item will have after the IR Process has been performed. In other words, the value of a used, but repaired, re-manufactured, or refurbished item. The IR Process described in this document was developed for electronic items, but is applicable to any other manufactured product.

The market value of a repaired, re-manufactured, or refurbished electronic item depends on many variables, including the speed with which technology is advancing, the degree within which the item can be returned to a “like-new” condition, and consumer acceptance of the “non-new” item. Consequently, a critical element in the IR Process is the maintaining of a current best estimate of the market value of all models and variations of the electronic items being processed. Non-electronic items may not be as highly sensitive to rapidly advancing technology, however, the need for accurate market value is just as important.

The key to profitably executing any of the IR Processes is to control the cost of labor and material. Often, especially with electronic items, the projected cost of labor and material can be greatly exceeded due to the requirement to repair failures not detected in the initial evaluation of the item. Therefore, it is extremely important to begin the IR Process with a thorough evaluation of the item condition, and a detailed list of probable required repairs. This allows for a projected cost of total labor and materials before further costs are expended. This also requires the maintaining of a data base of current costs associated with all known repairs for this item, including both labor and material.

Many companies are good at executing the steps up to this point. The failure in most systems is the ability to know when the point has been crossed where a profitable outcome from continuing the IR Process with a given item is no longer possible. The mistake so often made is to continue to spend on labor and material in an attempt to recover what has already been spent. Those are sunk costs and need to be recognized as such. The only decision to be made at this point is whether or not the labor required to remove all the material that has been used will be less than the value of the material recovered. If not, then the IR Process with this item should be terminated.

The IR Process is logical, and relatively simple. What is not simple is the execution. In order to fully deploy the IR Process, it is necessary to accurately track all labor and material expended on each individual item being processed. Each minute of labor, along with the applicable labor rate (including overhead) must be tracked. The full cost of each material component used must also be accounted for. And this must be accomplished in real time in order for the IR Process to work. Both of these cost components are tracked by a computer system that gathers cost components (labor and material) at each work station in the IR Process by the utilization of barcode scanners for both labor and material. This data is used to make a Pass/Fail decision at each work station to determine whether or not it is economically advisable to proceed with each individual item.

In summary, the IR Process implementation incorporates the variable data associated with initial functional and physical condition, material cost, labor cost, and market value to route material though each individual workstation. The Intelligent Routing tool allows for net value recovery maximization given the received state of each individual item in a reverse logistics/repair scenario.

### INTELLIGENT ROUTING TOOL

The intelligent routing process was specifically designed to optimize net value recovery in the reverse logistics process for manufactured goods. The reverse logistics process represents a unique set of challenges that differ from the forward logistics process. Specifically, the reverse logistics process is designed to accommodate product in a variety of initial state conditions (used, damaged, defective, open box . . . ) and, when optimized, to process that equipment to maximize recovered value or, in some cases, to insure the item will not be return to the primary market.

Optimizing Recovered Value

In the case where value recovery is desired, the net value recovery is defined as the positive value recovery total (including recovery through resale, parts recovery, and scrap recovery), less the recovery costs (including transportation, labor, and parts used). The positive value recovery total is a market dependent function. Conditions impacting this total include demand for refurbished product, as well as used products. There is also potential value recovery from parts and components associated with the item. This value recovery is also demand dependent and variable.

Minimizing Recovery Costs

The Intelligent Routing Process seeks to minimize costs associated with the reverse logistics process. There are three categories of costs that feed the Intelligent Routing tool. The first is the cost of logistics, the second is the labor cost by operation, and the third is parts consumption costs. Each of these costs reduce the net value recovery. In addition, labor and parts consumption cost can vary over time.

The entire optimization process can be summarized as the maximization of net value recovery for each individual item in the reverse logistics channel where net value recovery is defined as:

Net value recovery=Item Material Value Recoved+Item Resale Value Recovered+Opportunity Cost Recovered−Parts Cost−Labor Cost−Logistics Cost

Intelligent Routing Tool

The tool is designed to provide optimum net recovery for the item in the reverse logistics channel based on a routing methodology that is dynamically adjusted given the items current state and current market conditions. The steps in the process are as follows:

Establishment of Initial Conditions
Current Cost Parameter Feeds
Current Market Value per Condition
Current Standard Labor Rates by Operation

Establishment of Current Product Condition

Initial dynamic routing decisions are based on the initial functional and physical condition of the item entering the reverse logistics process. Routing decisions are made based on this condition assessment whether this assessment is made automatically or manually. Other factors that might impact this decision matrix include parts availability and forward market protection considerations (in some cases requiring certified destruction). Optimization of the routing function is achieved through a matrix decision tree that analyzes the financial outcomes of various routing alternatives and routes for net recovery maximization.

Routing Adjustments

As items proceed through the routing process, adjustments to the initial routing plan are made real time as specifics regarding the market, item physical, and item functional condition change or are modified. The adjustments are determined through the decision matrix based on item analysis at each phase of the process. Item analysis can be accomplished through an automatic, semi-automatic, or manual process based on the complexity of the task and the available technology. Data capture is then made through direct interface with the automated tool or through a manual data entry template. Data entry forms are designed to be operation specific and are adapted based on data feedback loops. The decision matrix from this information capture exists in the primary backend data structure as logic operations performed to result in a routing determination.

Feedback Loops

Essential elements of the intelligent routing schema are the feedback loops built into the system. Two types of feedback loops exist. The first is a physical routing search for the items that are identified to have functional or cosmetic conditions that require rework/re-verify within the system. These loops are created to insure optimal value recovery for the item is achieved. These loops often involve a re-work/repair operation or a reverification of a preceeding routing step. The key to these physical feedback loops is the capture of information in the automatic routing process that allows for adjustments and improvements in the process. Key design considerations for this type of feedback loop were establishment of a decision matrix that captured information on faults, both physical and functional. Additionally, economic factors such as labor rates and item recovery value influence the decision matrix to create optimum net financial performance. As part of the system, metrics are tabulated and reported to mitigate process failures and improve operator performance. Metrics recovered are similar to those in manufacturing processes, including labor per item, parts cost per item, and defect rate per labor hour or per operator.

The second feedback loop is information feedback. As items complete the processing step, new information is made available on current market conditions for the item in a given physical and functional state. This information may also include material value recovery. Adjustments to routing are made real time based on the feedback of this information to the decision matrix.

1. The Intelligent Routing process optimizes net value recovery in the reverse logistics process for manufactured goods. Its implementation incorporates the variable data associated with initial functional and physical condition, material cost, labor cost, and market value to route material though each individual workstation. The Intelligent Routing tool allows for net value recovery maximization given the received state of each individual item in a reverse logistics/repair scenario.
